(19) United States
(12) Patent Application Publication
(10) Pub. No.: US 2014/0130751 A1
(43) Pub. Date: May 15, 2014

(54) TRANSMITTER FOR DRIVING A PERIMETER WIRE OF AN ANIMAL MOVEMENT CONTROL SYSTEM

(71) Applicant: Barry R.J. Meikle, Woorim (AU)

(72) Inventors: Barry R.J. Meikle, Woorim (AU); Thomas Lipson, Tacoma, WA (US)

(73) Assignee: Barry R.J. Meikle, Woorim (AU)

(21) Appl. No.: 14/073,820

(22) Filed: Nov. 6, 2013

Related U.S. Application Data
(60) Provisional application No. 61/725,098, filed on Nov. 12, 2012.

(51) Int. Cl. A01K 15/02

(52) U.S. Cl. CPC A01K 15/021
USPC 119/721; 327/155

(57) ABSTRACT

A transmitter for driving a perimeter wire of an animal control system, in which a collar is attached to an animal, and the collar has a signal receiver configured to receive signals outputted to the perimeter wire by the transmitter. The collar is adapted to trigger a control stimulus responsive to detecting a pre-determined signal pattern received at the signal receiver. Different collars have different pre-determined signal patterns. The transmitter has a user interface allowing the transmitter to be configured to output the pre-determined signal pattern for a particular collar. In one aspect, the transmitter monitors current in the wire and adjusts signal magnitude driving the wire and achieves more consistent stimulus activation and detects system abnormalities. Data defining patterns for the different signal types can be stored in a database and be assembled into an appropriate pattern for a particular collar by a microprocessor.

### CROSS REFERENCE TO RELATED APPLICATIONS

This application claims priority from U.S. provisional patent application No. 61/61725098, filed on Nov. 12, 2012, entitled “TRANSMITTER FOR DRIVING A PERIMETER WIRE OF AN ANIMAL MOVEMENT CONTROL SYSTEM”, which is hereby incorporated by reference in its entirety for all purposes.

### BACKGROUND

1. Field

The following relates, in one aspect, to systems that control animal behavior, and in one more particular aspect, to a system for confining a domestic animal to an area enclosed by a perimeter wire.

2. Related Art

Electrified fences are known to be able to control animal behavior, such as electric fences for enclosing livestock grazing land. Such fences have relatively high installation costs and maintenance costs. In some cases, they also may present a shock hazard to unintended recipients.

An alternative system is to provide a system that provides a perimeter wire that encloses an area in which an animal is to be confined, a transmitter and a receiver. The transmitter drives the perimeter wire. The receiver is located in a collar attached to the animal. The collar also includes a shock generator. The shock generator is activated when the receiver detects a pre-programmed signal. The pre-programmed signal is generated by the transmitter and outputted to the perimeter wire.

### SUMMARY

In one aspect, the disclosure relates to a transmitter that is configurable to output a pre-programmed signal that activates each of a plurality of collars that each may respond to or recognize a different signal. The transmitter has a user interface that is capable of receiving a selection of a type of collar or system type, for which the transmitter will generate an appropriate signal. In one implementation, the transmitter can have a memory that stores a set of waveform types. For each pre-programmed signal to be supported, the memory stores a set of parameters that are used to construct the pre-programmed signal from the stored set of waveform types. Such parameters can include a selection of one or more of the waveform types, and for each selected waveform type, any of a frequency, an amplitude, a duration, a duty cycle, and a number of cycles can be specified, by way of example. Each pre-programmed signal can include a number of constituent elements. The stored data includes sequencing data that defines an order in which the constituent elements are to be generated and outputted to the perimeter wire.

Another aspect includes a sensor that monitors the current flow in the perimeter wire. The controller is configured to adjust a signal level of the output signal to the perimeter wire, in response to fluctuation in the measured current. The controller also can monitor the system for anomalies in the measured current and diagnose a problem or malfunction based on current, historical or both current and historical values of the measured current and other system conditions.

This summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a context in which a transmitter according to the disclosure can operate;

FIG. 2 depicts an example set of functional elements in a transmitter according to the disclosure;

FIG. 3 depicts an example process that can be implemented in a transmitter according to the disclosure;

FIG. 4 depicts a table that can be used to represent aspects of waveforms that can be generated by a transmitter according to the disclosure;

FIG. 5 depicts a table that can be used to represent aspects of waveforms that can be generated by a transmitter according to the disclosure;

FIG. 6 depicts a process that can be used to determine a final value of a waveform voltage that will be used to drive a perimeter wire for an animal control system;

FIG. 7 depicts an example process of updating parameters that can be used in the process of FIG. 6; and

FIG. 8 an example process for fault detection in an animal control system according to the disclosure.

### DETAILED DESCRIPTION

One characteristic of existing animal control systems that use a transmitter and collar that is activated in response to a received signal is that each has a proprietary protocol transmitted on the perimeter wire (according to a pre-determined signal pattern), in order to trigger the corrective stimulus applied to the animal. Thus, transmitters of one type do not activate collars of a different type, and vice versa. Providing a configurable transmitter that can be used to generate signals that activate a wide range of collars provides an opportunity for consumers to avoid being locked into a particular proprietary system.

The following describes aspects of implementing a transmitter that can be used with a variety of existing animal control systems, and also in new installations. Features in accordance with the description can be provided, which include fault detection and adaptive power correction.

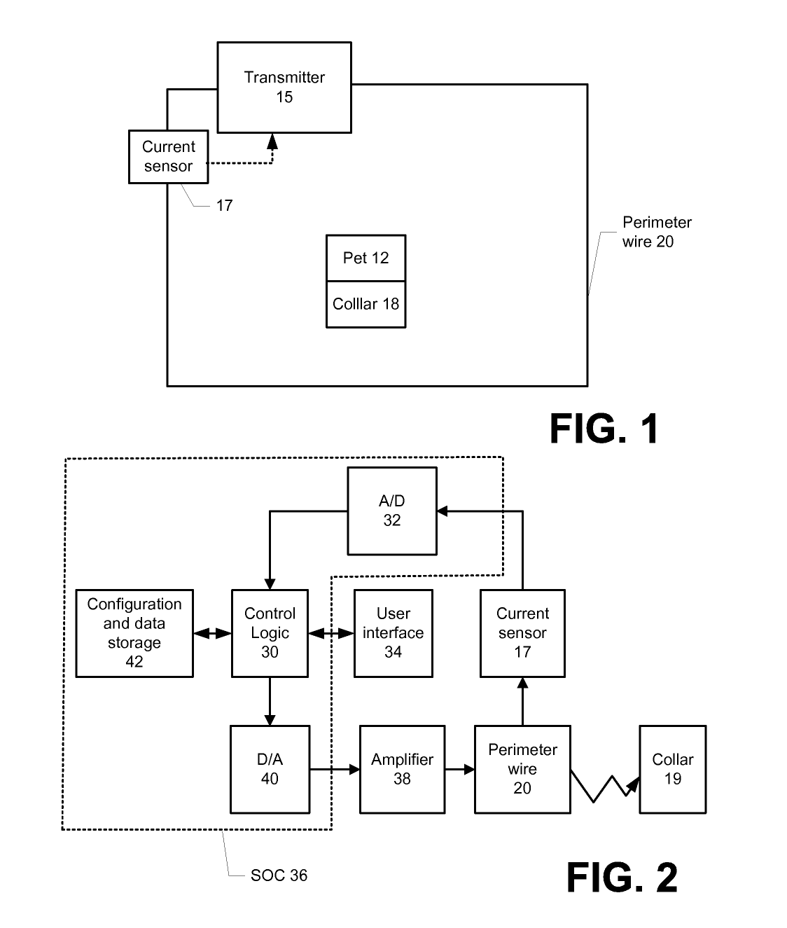

FIG. 1 depicts an arrangement with a transmitter 15 coupled with a perimeter wire 20. The perimeter wire 20 couples with a current sensor 17 that outputs to the transmitter 15. FIG. 1 depicts a pet 12 coupled with a collar 18 that is capable of applying a corrective stimulus to the pet 12. The corrective stimulus can be one or more of a variety of stimuli; in an example, the corrective stimulus comprises electrical discharges.

FIG. 2 depicts an example implementation of transmitter 15. Transmitter 15 comprises control logic 30 that interfaces with configuration and data storage 42. Configuration and data can be implemented using a memory. Control logic 30 is operable to interface with a digital to analog convert (D/A) 40 which outputs an analog value to an amplifier 38. Amplifier 38 couples with perimeter wire 20.

A user interface 34 interfaces with control logic 30. Control logic 30 also is operable to receive inputs from an analog to digital converter (32) that couples with current sensor 17 to sample and convert analog samples of current in perimeter wire 20. A dashed line demarcates a boundary of a system on chip (SOC) 36 that includes control logic 30, A/D 32, D/A 40 and configuration and data storage 42.

In a particular example, SOC 36 may include a programmable processor that implements control logic 30, with configuration (e.g., machine readable code) obtained from configuration and data storage 42. Control logic 30 also may use storage 42 as a working memory during operations described below. Example operational aspects of transmitter 15 and other components depicted in FIGS. 1 and 2 are explained below.

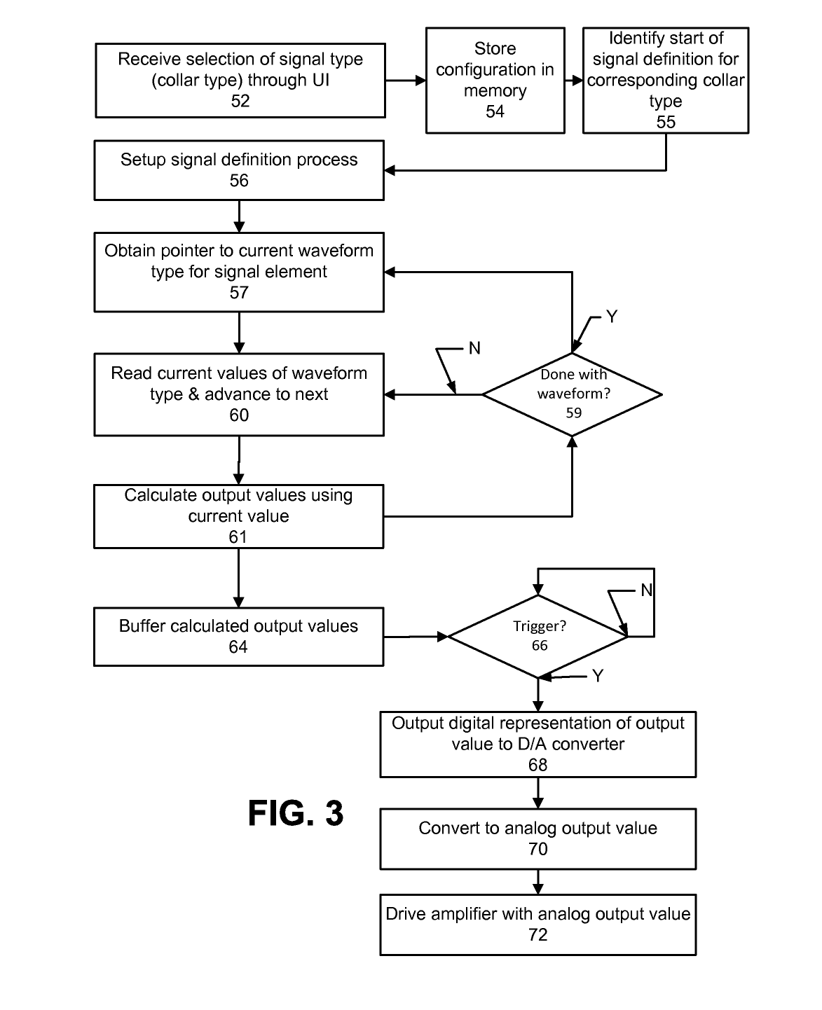

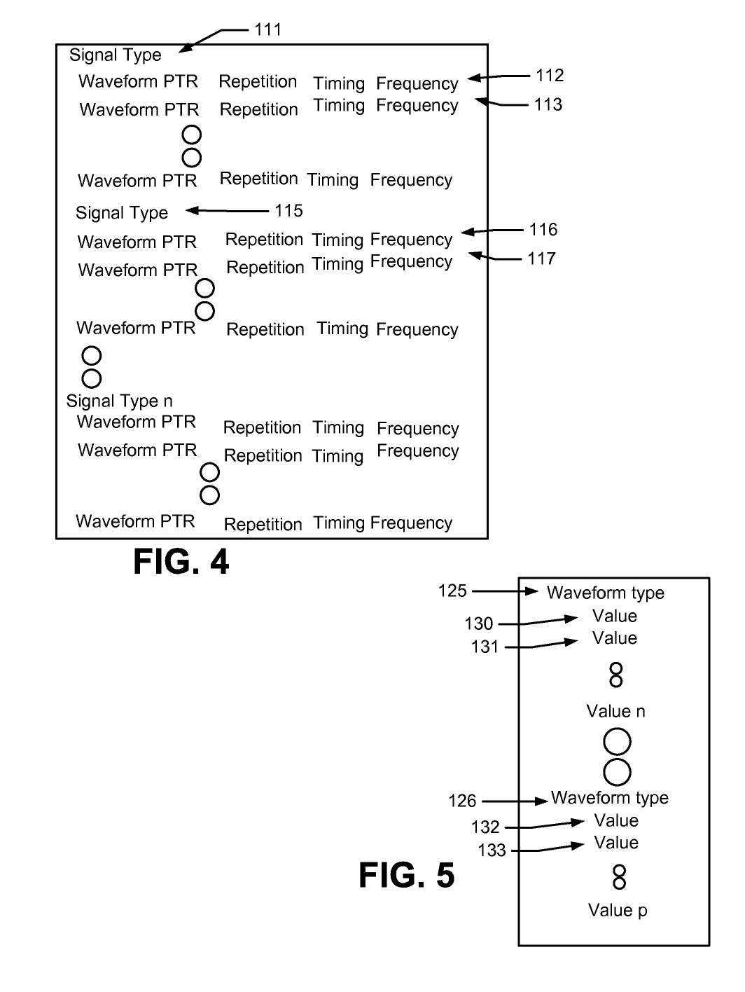

FIG. 3 depicts an example process for generating a waveform that will be able to activate a particular kind of collar, which is expecting a pre-determined waveform pattern. The process of FIG. 3 uses data describing waveform components, examples of which are provided in FIGS. 4 and 5, and described below.

At 52, a selection of signal type is received. Such selection of signal type can be implemented through a user interface provided with transmitter 15. For example, transmitter 15 can be pre-programmed to support a variety of output waveforms that activate a variety of different collar types. The user interface can include a button that accepts inputs to scroll through a list of supported collar varieties displayed on a Liquid Crystal Display (LCD). Other kinds of user interfaces can be provided, which allow such selection. At 54, the selection of a collar to be supported (i.e., that transmitter 15 is to generate a waveform that will activate that kind of collar) is stored.

The example process of FIG. 3 continues with steps to generate the waveform appropriate for the selected collar. In an example, at 55, a start of a signal definition corresponding to the selected collar type is identified. Considering FIG. 4, FIG. 4 depicts a plurality of supported signal types, with signal types 111 and 115 identified. Each of these signal types can be for supporting a different kind of collar, for example. Each signal type has one or more constituent waveform elements. For example, constituent waveform elements 112-113 and 116-117 are depicted respectively for signal type 111 and signal type 115. Each waveform element has a set of definitional information that defines the nature of that waveform element. A sequence in which the waveform elements are stored, linked, or otherwise organized in memory can be used to determine a relative order of the generation of those waveform elements by transmitter 15.

In an example, each waveform element includes a waveform pointer that identifies a canonical waveform type for that waveform element, other information can include repetition, timing, and frequency information. For example, waveform element 112 can be a sine wave burst at a frequency of 10 kHz, and is to last 50 ms for each of a defined number of repetitions. The timing and repetition information can be expressed as a duty cycle and a number of repetitions, as well. In such approach example of a waveform element definition can be a sine wave of 10 kHz, with 25 ms on time at a 25% duty cycle, repeated 10 times. Other approaches to waveform element definition can include a hierarchical construction that defines a waveform element by two or more constituent components, where the waveform element as a whole can be generated one or more times, causing generating of each of the constituent components in a pre-defined sequence. For example, instead of defining a duty cycle, the above example can be defined as a sine wave lasting 25 ms following by silence of 75 ms off and that sequence is indicated to be repeated 10 times. Thus, it would be apparent to a person of ordinary skill from the above examples that a variety of implementations of the data used to generate the waveforms can be provided.

In the above example, the waveform to be generated is described by a canonical waveform definition. An example of such an approach is found in the table depicted in FIG. 5, where a waveform type 125 is defined by a series of values (values 130 and 131 depicted) and a waveform type 126 is defined by values 132-133 and so on. Each waveform type can have the same number of definitional values, or can be varied. In one example, each waveform can be defined by 10 values. A number of values used to define each waveform type can be selected in accordance with a sampling rate of a digital to analog converter (e.g., D/A 40 of FIG. 2) and maximum frequency content of a waveform that will be produced. As explained below, each of these values serves as a basis for determining a final value to be applied to D/A 40, which will drive amplifier 38, when generating a waveform according to the waveform type to which that value is related.

Having explained aspects of data to be used in the process of FIG. 3, further details concerning the process are provided below. At 56, an approach to generating the specific waveform identified at 55 is setup. Such setup undertaken, if any, may depend on how the data representing each waveform is structured. For example, if the waveform data includes a separate definition for each element, and a repetition, then a loop may be initialized according to the type of repetition required. Also, where the data represents, for example, one cycle of a given waveform, then the timing of the output of each final calculated value would depend on the frequency content of the waveform sought to be generated. For example, for a 20 kHz waveform, the final values calculated for each of the set of 10 values needs to be presented to the D/A twice as fast as a 10 kHz waveform.

At 57, a pointer (e.g., 111) to the particular waveform type (see FIG. 5) being used is used to access the values that will be used to define that waveform type. At 60, one or more values in the sequence of values for that waveform type is accessed, and an index can be incremented. For example, a digital representation of a signal value is read from the waveform type information (e.g., value 130 or value 131). The digital representation can use, for example 8, 10, 12 bits, or 16 bits. Each value represents a starting point for calculating a final value that will be used as input to D/A 40. In one implementation, values are read in groups, such as a group of 10 values. In one approach, the same processing is applied to each value read as a group (and for example, transmit power adaptation can be performed on groups of values).

At 61, a final output value is calculated based on the value that was read at 57. After 61, a decision is made whether all the values for that waveform type have been consumed, and if so, then 57 is repeated. Additionally, at 64, the value calculated at 61 can be buffered awaiting a trigger to output the value to a D/A. At 66, when the trigger arrives (e.g., a clock signal or interrupt), then at 68, the value is outputted. At 70, that value is converted to an analog value. At 72, that value is used to drive an amplifier (amplifier 38 of FIG. 2) that is coupled to perimeter wire 20.

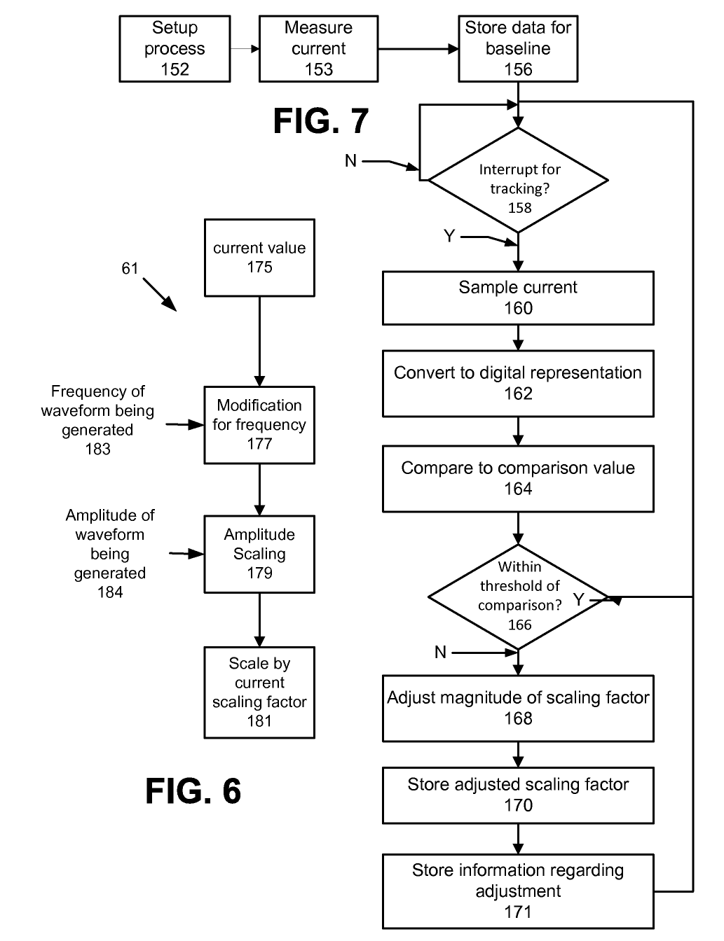

FIG. 6 depicts a process by which calculation 61 in FIG. 3 can be implemented. FIG. 6 depicts that a current value obtained from the table depicted in FIG. 5 can be inputted to a function 177 that will modify the value read based on a frequency of a waveform to be generated. Where a waveform is periodic and there is a complete cycle represented by the values stored in the table of FIG. 5, then this function will modify a timing of delivery for a final value, which will be based on frequency of the signal being generated and can simply replicate the samples. Where waveform elements deviate from simple tones and become more complicated, then a set of samples can be selected according to a frequency content of the waveform element. A Nyquist-Shannon sampling criteria calls for having at least twice as many samples as the highest frequency in the periodic signal, to be able to fully and completely represent the signal. However, that requirement may not be necessary in every system, and in some approaches, some amount of undersampling may be acceptable. For example, if a given collar variety is reliably activated by a signal with a certain amount of distortion due to undersampling, then it may be acceptable to provide an undersampled representation of the signal for that collar.

At 179, each waveform specified in the table of FIG. 4 may have amplitude information, and if so, the value obtained from the table of FIG. 5 can be scaled by the amplitude from the appropriate entry of Table 4. At 181, the value resulting from that scaling may be further scaled according to a scaling factor that is maintained by a feedback system, which will be described with respect to FIG. 7. These scaling factors can be combined into one operation. Some implementations may modify values stored on memory by a current scaling factor, before they are needed, but that approach would require more updating of values, in response to changes in the scaling factor, which is desirably avoided.

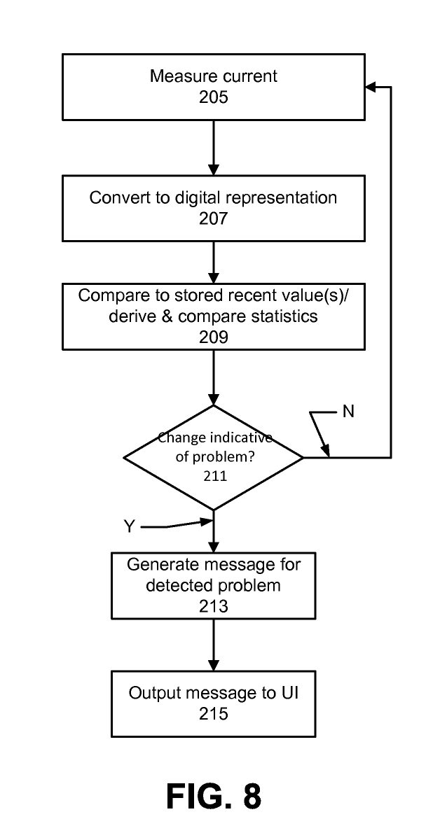

FIG. 7 depicts an example process for setting a sensitivity of collar activation, in a particular installation, and making collar activation more consistent over time. Without an approach that implements aspects of FIG. 7, activation of a collar would vary based on characteristics of the overall installation, and can also exhibit variation due to changes in environment conditions, and degradation of components used in the system. Aspects of FIG. 7 also provide inputs that can be used to diagnose system faults or other conditions that may need attention, as explained with respect to FIG. 8.

As depicted in FIG. 1, a perimeter wire 20 can enclose an area in which an animal, e.g., a domesticated animal, can be confined. The area can vary in size and dimension, such that perimeter wire 20 can vary greatly in length. Given that the perimeter wire 20 has some losses in transmission, due to impedance (mostly resistive in the present system), different length wires will have different losses. Different amounts of losses in different perimeter wires 20 would cause different activation experiences for the collar. For example, on a short wire, where losses were low, the radiated power of the perimeter wire 20 would be higher than a long wire where losses were higher. So, for a collar that is configured to activate when received power reaches a threshold level (of a specific signal), that collar would activate in different relative positions, for a given output transmitter power, depending on a length of perimeter wire 20.

At 152, a setup process is conducted. A setup process can involve a user connecting transmitter 15 to perimeter wire 20, placing a collar at a desired activation location, relative to perimeter wire 20, and then adjusting an output power of transmitter 15 until the collar activates at the desired activation location. For example, a button can be provided that allows cycling through an available set of power levels until the collar activates in a desired location (e.g., one or more feet away from the perimeter wire 20).

A power level determined according to such an initialization process can be considered to be an established baseline power level. At 153, that power level can be correlated with measured value of current in perimeter wire 20. At 156, the established baseline is represented by data that is stored. Subsequently, the system can be operational.

During normal operation, an interrupt can be triggered each time an output power level update is to be performed. Such an interrupt can be an interrupt solely for the purpose of power level updating, or can be an interrupt that is to activate a routine for producing waveform values to be outputted to D/A 40. In one example, an interrupt routine to read waveform type values (as in the example of FIG. 5) can read multiple values and process these values into final values for output to D/A 40. Such interrupt routine also can perform power level updating. In such an approach, an output power level can be adjusted once for each set of values read during one execution of the interrupt routine.

Thus, at 158, when an interrupt occurs, at 160, a current through perimeter wire 20 is sampled (e.g., by current sensor 17); as explained above, such interrupt may also trigger other processing or memory transactions. At 162, that sampled current is converted to a digital representation, e.g., using A/D converter 32. At 164, that converted sampled current is compared with a comparison value. Such comparison value may be the initial current value determined during setup. At 166, a decision whether the converted sampled current is within a threshold value of the comparison value is performed. If there is greater than a threshold difference, then a magnitude of the scaling factor applied at 181 in FIG. 6 is adjusted, and that adjusted scaling factor is stored at 170. The scaling factor scales an output voltage that is applied across perimeter wire 20, such that the current in perimeter wire 20 can maintained constant within a threshold of an intended value, which in turn maintains an effective power output from perimeter wire 20.

If the current sample is within a threshold, or after the adjusted scaling factor is stored, the method returns to 158 to wait for a subsequent interrupt. In one example, the scaling factor is adjusted one minimum step size each time that the sampled current deviates from the baseline by more than a threshold (in an appropriate direction). For example, if the scaling factor is represented as a 10 bit number, then each increment can be a linear change of the range divided by 2̂10 (1024). At 171, information regarding the adjustment can be recorded. For example, information regarding a time at which the scaling factor was adjusted can be recorded. Also, it may be desirable to store a difference between an initial scaling factor and a current scaling factor.

In another example, if there is a known non-linearity in the amplifier, the scale factor can be adjusted to make the actual voltage change on perimeter wire 20 more linear. In other examples, the scaling factor can be adjusted by an amount that the sampled current deviates from the baseline, a small deviation results in a small update, and a large deviation in a larger update. Appropriate safeguards may be put in place to handle a wire break or other abnormal operating condition, so that very large scaling factor adjustments are not made when there is a wire break, for example.

FIG. 7 thus presents an example implementation by which transmitter 15 output current can be adjusted automatically in order to maintain a consistent measured current, regardless of variations in resistance of perimeter wire 20. For example, what once may have been a fairly large difference in resistance, due to changes in ground water content, depending on the age of perimeter wire (e.g., degradation of insulation or of the conductor element), may be automatically compensated. Automatic compensation in turn allows a consistent experience for the animal, in that it will receive corrective stimuli more predictably. Thus, the process of FIG. 7 can be viewed as a process that seeks to maintain an effective power output of the perimeter wire within a threshold of a target.

Such compensation process can be implemented differently, so long as the compensation process operates to adaptively adjust an output voltage in response to changing conditions in order to reduce fluctuations in effective output power. Processes according to such an implementation also may involve sensing a variety of conditions, and then using values for these sensed conditions to estimate how these conditions would affect the effective power output.

FIG. 8 depicts an example process by which the sampled current values (at 160 of FIG. 7) can be used to detect system faults or degradation. For completeness, FIG. 8 depicts that the process includes sampling of current in perimeter wire 20, and converting that sample to a digital representation at 207. The stored samples may be a running set of recent samples. One or more statistics may be derived from the samples as they were taken. For example, a running average of samples may be maintained. For example, a difference or series of differences between a current scaling factor and an initial scaling factor can be maintained. Alternatively, voltage-related statistics can be maintained. At 211, a determination whether there is a change indicative of a problem evident in the data. If there is such a problem, then at 213, a message can be generated that indicates the detected problem. At 215, the generated message is outputted to the UI. A message can be a text message displayed on a display, or conveyed through a beep code, or another way to communicate the information.

Examples of problems that can be detected include a gradual degradation in perimeter wire 20. A gradual degradation in perimeter wire 20 is inferred when there is a repeated change (e.g. increase or decrease) in the resistance of perimeter wire 20. Thresholds for a minimum change can be set to exclude changes in current that may be due to seasonal changes and other conditions that may affect resistivity. For example, different climates may have different temperature swings between day and night, and between summer and winter. A required minimum change can be based on gathering a set of statistics for the behavior of the perimeter wire over a period of time. The threshold also can be set based on a threshold designed to be greater than changes that would be attributable to these effects. Such threshold also can be set based on the dynamic range of the power output of amplifier 38, in that the perimeter 20 can deteriorate to an extent linked to the capability of amplifier 38 to accommodate such degradation. Another problem that can be detected is that perimeter wire 20 has a break, which is detected by detecting a lack of current flow. Such a break also can be detected by comparing the detected current with a comparison current value. In the graduation degradation situation, a response time may be extended, since the condition is a graduation deterioration that can be compensated to some degree through amplifier 38. However, where there is a break, the message should be generated (213) and outputted (215) quickly.

The waveform definition approach described here thus can be viewed as providing a relatively simple procedural approach to waveform definition that does not consume much processor or memory resources for types of signals that are adequate for the usage here.

Transmitter 15 can be manufactured with a database (e.g., data according to FIGS. 4 and 5) that allows selection from a variety of supported products. In another implementation, transmitter 15 can be configured to be updated by connection to another electronic device, such as a computer or smart phone. In another approach, a device can be used to select a collar type or model for which a signal pattern is to be generated (e.g., on a UI of a smart phone), and allow that choice to be propagated to transmitter 15, such as through a USB connection. A variety of other approaches to initializing, updating, or trouble shooting transmitter 15 can be implemented according to the disclosure. In general, however, transmitter 15 is setup to be a self-contained unit that has a simple interface that allows selection of a collar type and also supports an approach to setting a range at which the collar is desired to be activated.

Aspects of functions, and methods described and/or claimed may be implemented in a special purpose or general-purpose computer including computer hardware, as discussed in greater detail below. Such hardware, firmware and software can also be embodied on a video card or other external or internal computer system peripherals. Various functionality can be provided in customized FPGAs or ASICs or other configurable processors, while some functionality can be provided in a management or host processor. Implementations also may use lower scale integration circuit elements, such as LSI components, and even individual transistors, as well as discrete components. Components can be coupled using printed circuit boards, by integration, or other suitable approaches that would be understood from the disclosure by those of ordinary skill.

In addition to hardware embodiments (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL) and so on, or other available programs, databases, and/or circuit (i.e., schematic) capture tools. Embodiments can be disposed in computer usable medium including non-transitory memories such as memories using semiconductor, magnetic disk, optical disk, ferrous, resistive memory, and so on.

As specific examples, it is understood that implementations of disclosed apparatuses and methods may be implemented in a semiconductor intellectual property core, such as a microprocessor core, or a portion thereof, embodied in a Hardware Description Language (HDL)), that can be used to produce a specific integrated circuit implementation. A computer readable medium may embody or store such description language data, and thus constitute an article of manufacture. A non-transitory machine readable medium is an example of computer readable media. Examples of other embodiments include computer readable media storing Register Transfer Language (RTL) description that may be adapted for use in a specific architecture or microarchitecture implementation. Additionally, the apparatus and methods described herein may be embodied as a combination of hardware and software that configures or programs hardware.

Also, in some cases terminology has been used herein because it is considered to more reasonably convey salient points to a person of ordinary skill, but such terminology should not be considered to impliedly limit a range of implementations encompassed by disclosed examples and other aspects.

Also, a number of examples have been illustrated and described in the preceding disclosure, each illustrating different aspects that can be embodied systems, methods, and computer executable instructions stored on computer readable media according to the following claims. By necessity, not every example can illustrate every aspect, and the examples do not illustrate exclusive compositions of such aspects. Instead, aspects illustrated and described with respect to one figure or example can be used or combined with aspects illustrated and described with respect to other figures. As such, a person of ordinary skill would understand from these disclosures that the above disclosure is not limiting as to constituency of embodiments according to the claims, and rather the scope of the claims define the breadth and scope of inventive embodiments herein. The summary and abstract sections may set forth one or more but not all exemplary embodiments and aspects of the invention within the scope of the claims.

We claim:

1. A transmitter for use with an electronic pet control system having a perimeter wire and a collar for securing to an animal, and comprising a signal receiver, the collar configured to apply a corrective stimulus to the animal, in response to receiving a pre-determined signal pattern, the transmitter comprising:
a signal generator capable of being coupled to the perimeter wire through an amplifier having an input driven by a digital to analog converter that receives an input from the signal generator, the signal generator capable of being configured to receive an input from a user interface indicative of a selection of the pre-determined signal pattern of the collar, from a plurality of signal patterns defined in a non-transitory storage medium coupled to the signal generator.

2. The transmitter of claim 1, wherein the signal generator is further configurable to receive an input from a user interface indicative of a selection of the pre-determined signal pattern of the collar, from a plurality of signal patterns defined in a non-transitory storage medium coupled to the signal generator.

3. The transmitter of claim 1, wherein the signal generator is configured to maintain a variable output voltage to the perimeter wire, the output voltage selected to maintain an approximately constant current in the perimeter wire as resistance in the perimeter wire varies.

4. An electronic animal movement control system, comprising:
a collar for attaching to an animal, comprising a signal receiver, a stimulus generator configured for administering a stimulus to the animal, and a controller to process signals received from the signal receiver and to activate the stimulus generator in response to detecting a pre-determined signal pattern;
a wire for enclosing a perimeter of an area in which the animal is to be confined; and
a transmitter coupled to an amplifier with an input driven by a digital to analog converter that receives an input from a controller, the controller capable of being configured to receive an input from a user interface indicative of a selection of the pre-determined signal pattern required to activate the collar, from a plurality of signal patterns, and wherein the transmitter is configured to inject a signal pattern into the perimeter wire determined according to the input received from the user interface.

5. The electronic animal movement control system of claim 1, wherein the transmitter further comprises a non-transitory computer readable medium storing a digital representation of the pre-determined signal pattern comprising a plurality of signal elements, each signal element comprising a waveform type, and a waveform frequency.

6. The electronic animal movement control system of claim 1, wherein the transmitter further comprises a non-transitory computer readable medium storing a respective digital representation of each signal pattern of the plurality of signal patterns, each digital representation comprising a linked list having an entry for each waveform element in that signal pattern, each entry defining a waveform type for that waveform element.

7. The electronic animal movement control system of claim 1, wherein the controller of the transmitter further is operable to obtain samples of current in the perimeter wire and to adjust a scaling factor applied to values applied to the digital to analog converter to track a baseline current.

8. The electronic animal movement control system of claim 1, wherein the controller further is operable to obtain samples of current in the perimeter wire and to detect a trend in the values of the samples indicative of a abnormal operating condition and output a message indicating the abnormal operating condition to the user interface.

9. The electronic animal movement control system of claim 1, wherein the controller further is operable to obtain samples of current in the perimeter wire and to detect a failure in the perimeter wire by the samples approaching a zero value.

10. A transmitter for use with an electronic pet control system having a perimeter wire and a collar for securing to an animal, and comprising at least two electrodes, and a signal receiver, the collar configured to apply a corrective stimulus to the animal, in response to receiving a pre-determined signal pattern, the transmitter comprising:
a signal generator capable of being coupled to the perimeter wire through an amplifier having an input driven by a digital to analog converter that receives an input from the signal generator,
the signal generator operable to access values in a digital representation of a waveform type, to scale those values according to a scale factor, and to maintain the scale factor by setting an initial scale factor during a setup process by which input is received through the user interface indicative of an initial output power level.

11. A transmitter for use with an electronic pet control system having a perimeter wire and a collar for securing to an animal, comprising a signal receiver, the collar configured to apply a corrective stimulus to the animal, in response to receiving a pre-determined signal pattern, comprising:
a non-transitory memory storing data describing constituent components of a plurality of signal patterns and data describing a pattern;
a controller coupled with the memory and with a user interface, and configured
to receive input through the user interface,
to interpret the received input as a selection of one signal pattern of the plurality of signal patterns,
to access the data describing the constituent components of the selected signal pattern from the memory, and
to output a timed sequence of the constituent components;
a digital to analog converter to receive the timed sequence of the constituent components and produce an analog representation of each constituent component; and
an amplifier to receive the analog representation of each constituent component and apply an amplification factor to the analog representation of each constituent component to produce an amplified analog representation of each constituent component, and apply the amplified analog representation of each constituent component to the perimeter wire.

12. A transmitter for use in an electronic pet control system having a perimeter wire and a collar for securing to an animal, and comprising a signal receiver, the collar configured to apply a corrective stimulus to the animal, in response to receiving a pre-determined signal pattern, the transmitter coupled with the perimeter wire to input an electric potential across two leads of the perimeter wire, comprising:
a non-transitory memory storing data describing a plurality of signal patterns that each can activate a collar of a different type, when received by that collar;
a controller coupled with the memory and with a user interface, and configured
to receive input through the user interface,
to interpret the received input as a selection of one signal pattern of the plurality of signal patterns,
to access data values describing the selected signal pattern from the memory, and
to modify the data values of the selected signal pattern to maintain electric current flow in the perimeter wire within a threshold of a selected current flow level;
a digital to analog converter to receive the modified data values and produce an analog waveform based on the modified data values; and
an amplifier to receive the analog waveform, to amplify the analog waveform and apply the amplified analog waveform to the perimeter wire.

13. A machine-implemented method of driving a perimeter wire for use in an electronic animal control system with a collar to be secured to an animal, and comprising a signal receiver, the collar configured to apply a corrective stimulus to the animal, in response to receiving a pre-determined signal pattern, the method comprising:
establishing a baseline output power level of an amplifier coupled to the perimeter wire and an initial sample of current flow in the perimeter wire correlated to the baseline output power level when the baseline output power level is established; and
periodically sampling the current in the perimeter wire and if the sampled current is less than the initial sample of current then increasing an output power level by at least a minimum step size, and if the sampled current is greater than the initial sample of current then decreasing the output power level by at least the minimum step size.

14. The machine-implemented method of driving a perimeter wire for use in an electronic animal control system of claim 12, further comprising detecting a repeated deviation of the updated samples of current flow from the initial sample of current flow and in response, outputting an indication of a fault condition through a user interface.

15. A non-transitory machine readable medium storing data and machine executable instructions, comprising:
data defining a plurality of signal patterns, each signal pattern comprising a waveform element sequence comprising at least one waveform element shape, and a respective frequency at which each of the waveform elements shapes is to be generated; and
machine executable instructions for programming a processor to perform a method comprising:
obtaining an indication of a selected signal pattern, of the plurality of signal patterns,
establishing a current waveform element shape for the selected signal pattern,
determining a value to be applied to a digital to analog converter using the current waveform element shape, a respective frequency of the waveform element shape and a scale factor,
applying the determined value to an output of the processor coupled with a digital to analog converter, and
updating the current waveform element to a subsequent waveform element in the sequence and repeating the method.
